(19) United States
(12) Patent Application Publication
(10) Pub. No.: US 2024/0204551 A1
(43) Pub. Date: Jun. 20, 2024

(54) BUCK-FED QUASI-RESONANT CURRENT MULTIPLIER

(71) Applicant: Apple Inc., Cupertino, CA (US)

(72) Inventor: Vijay G Phadke, San Jose, CA (US)

(21) Appl. No.: 18/068,338

(22) Filed: Dec. 19, 2022

(51) Int. Cl. H02J 7/00; H02M 3/07

(52) U.S. Cl. CPC H02J 7/00714; H02M 3/073; H02J 2207/20

(57) ABSTRACT

A buck-fed current multiplier battery charging circuit can include a buck converter having an input configured to receive an input voltage and an output configured to deliver a regulated current, a current multiplier having an input configured to receive the regulated current from the buck converter and an output configured to deliver a multiple of the regulated current to a battery, wherein the current multiplier comprises one or more flying capacitor stages each including a resonant tank circuit; and controller circuitry coupled to the buck converter that operates switches of the buck converter to produce the regulated current and coupled to the current multiplier that operates switches of the current multiplier to deliver the multiple of the regulated current to the battery.

### BACKGROUND

Increased usage of mobile electronic devices places significant power demand on the batteries of such devices. Longer battery runtime requires larger batteries, which, in some cases may be cost prohibitive or adversely impact size and weight of the device. As a result, battery charging cycles occur more frequently. For at least some users, battery charging cycles during the day, as opposed to overnight while the user is sleeping, are common. Thus, users generally prefer that the battery charge as quickly as possible so as to be able resume “normal” device usage (i.e., usage without being connected to a wired or wireless power source for charging) as soon as possible. Advancements in battery chemistry have allowed for higher battery charging rates, but in at least some instances, thermal and efficiency constraints of the charger circuitry may become the factor that limits battery charging rates.

### SUMMARY

Thus, it may be desirable to provide battery charging circuits for electronic devices that have improved efficiency that can allow for higher battery charging rates.

A buck-fed current multiplier battery charging circuit can include a buck converter having an input configured to receive an input voltage and an output configured to deliver a regulated current, a current multiplier having an input configured to receive the regulated current from the buck converter and an output configured to deliver a multiple of the regulated current to a battery, wherein the current multiplier comprises one or more flying capacitor stages each including a resonant tank circuit; and controller circuitry coupled to the buck converter that operates switches of the buck converter to produce the regulated current and coupled to the current multiplier that operates switches of the current multiplier to deliver the multiple of the regulated current to the battery. The one or more flying capacitor stages can include at least one first flying capacitor stage forming a first phase of the current multiplier and at least one second flying capacitor stage forming a second phase of the current multiplier, wherein the first and second phases are operated in an interleaved manner to reduce current or voltage ripple.

Each of the one or more flying capacitor stages can include a flying capacitor and a flying inductance forming the resonant tank circuit, a high side complementary switch pair coupled to a first terminal of the resonant tank circuit, and a low side complementary switch pair coupled to a second terminal of the resonant tank circuit. The flying inductance can include a parasitic inductance or can be a parasitic inductance. The flying inductance can be parasitic inductance. The controller circuitry can operate the high side complementary switch pair and the low side complementary switch pair of the one or more of the flying capacitor stages with a 50% duty cycle to alternate between charging the flying capacitor in series with the battery and discharging the flying capacitor in parallel with the battery. The one or more flying capacitor stages can discharge with a quasi-resonant current. The one or more flying capacitor stages charge with a quasi-resonant current.

The buck-fed current multiplier battery charging circuit can further include a clamp diode coupled between the output of the buck converter and the input of the buck converter. The buck-fed current multiplier battery charging circuit can further include a clamp capacitor coupled to the output of the buck converter. The controller circuitry can operate the buck converter at a switching frequency that is synchronized with and an even integer multiple of a switching frequency of the current multiplier. The controller circuitry can operate the buck converter at a switching frequency that is not synchronized with or a multiple of the switching frequency of the current multiplier. The current multiplier comprises at least three flying capacitor stages, providing for selection of integer multiples of 4×, 3×, 2×, or 1×.

A method of operating a buck-fed current multiplier battery charging circuit can include operating a buck converter input stage at a first switching frequency to produce a regulated current and operating a current multiplier stage at a second switching frequency to produce a battery charging current that is an integer multiple of the regulated current, wherein the current multiplier stage comprises one or more flying capacitor stages including a resonant tank circuit.

Each of the one or more flying capacitor stages can include a flying capacitor and a flying inductance forming the resonant tank circuit, a high side complementary switch pair coupled to a first terminal of the resonant tank circuit, and a low side complementary switch pair coupled to a second terminal of the resonant tank circuit, wherein operating the current multiplier stage can include operating the high side complementary switch pair and the low side complementary switch pair of the one or more flying capacitor stages with a 50% duty cycle to alternate between charging the flying capacitor in series with a battery and discharging the flying capacitor in parallel with the battery.

The one or more flying capacitor stages can discharge with a quasi-resonant current. The one or more flying capacitor stages can charge with a quasi-resonant current. The first switching frequency can be synchronized with and an even integer multiple of the second switching frequency. The first switching frequency can be not synchronized with the second switching frequency.

A battery charging circuit can include means for generating a regulated current from an input voltage source and means for generating a battery charging current that is an integer multiple of the regulated current from the regulated current, wherein the means for generating the battery charging current includes one or more resonant tank circuits that are alternated between a first state that includes storing energy in the resonant tank circuit and discharging energy from the resonant tank circuit to the battery. The one or more resonant tank circuits can discharge with a quasi-resonant current. The one or more resonant tank circuits can charge with a quasi-resonant current.

### BRIEF DESCRIPTION OF THE DRAWINGS

FIG. 1 illustrates a block diagram of a battery charger system.

FIG. 2 illustrates a schematic of a buck-fed quasi-resonant current multiplier in which the current multiplier is a current doubler.

FIG. 3 illustrates switch drive signals of the buck-fed quasi-resonant current multiplier of FIG. 2.

FIG. 4 illustrates various current waveforms of the buck-fed quasi-resonant current multiplier of FIG. 2.

FIG. 5 illustrates various current waveforms of the buck-fed quasi-resonant current multiplier of FIG. 2.

FIG. 6 illustrates a schematic of a buck-fed quasi-resonant current multiplier in which the current multiplier is a current quadrupler.

### DETAILED DESCRIPTION

In the following description, for purposes of explanation, numerous specific details are set forth to provide a thorough understanding of the disclosed concepts. As part of this description, some of this disclosure's drawings represent structures and devices in block diagram form for sake of simplicity. In the interest of clarity, not all features of an actual implementation are described in this disclosure. Moreover, the language used in this disclosure has been selected for readability and instructional purposes, has not been selected to delineate or circumscribe the disclosed subject matter. Rather the appended claims are intended for such purpose.

Various embodiments of the disclosed concepts are illustrated by way of example and not by way of limitation in the accompanying drawings in which like references indicate similar elements. For simplicity and clarity of illustration, where appropriate, reference numerals have been repeated among the different figures to indicate corresponding or analogous elements. In addition, numerous specific details are set forth to provide a thorough understanding of the implementations described herein. In other instances, methods, procedures, and components have not been described in detail so as not to obscure the related relevant function being described. References to “an,” “one,” or “another” embodiment in this disclosure are not necessarily to the same or different embodiment, and they mean at least one. A given figure may be used to illustrate the features of more than one embodiment, or more than one species of the disclosure, and not all elements in the figure may be required for a given embodiment or species. A reference number, when provided in a given drawing, refers to the same element throughout the several drawings, though it may not be repeated in every drawing. The drawings are not to scale unless otherwise indicated, and the proportions of certain parts may be exaggerated to better illustrate details and features of the present disclosure.

As noted above, users of electronic devices may prefer that the batteries of such devices charge as quickly as possible. In some cases, thermal limits relating to the efficiency of the battery charging circuitry may be the factor that limits charging rate. Direct charging technology has been introduced to the industry, with the aim of reducing power losses in the internal charger circuit of the device. When employing direct charging technology, the AC/DC adapter can have a special feature to operate as a constant current source with defined range and resolution of operation. Such a power adapter may be known as a Programmable Power Source or “PPS”. The current regulation set point of such a PPS adapter may be set by the electronic device, for example using a Universal Serial Bus Power Delivery (USB-C/USB-PD) digital communications. As a result, the PPS power adapter can be directly connected to the device's battery via an internal switching capacitive voltage divider that also functions as current multiplier. Such capacitive voltage dividers may also be known as “Switched Capacitor Converters,” “SwCap Converters.” or “Flying Capacitor Converters.” Such circuits are in some respects similar to a transformer in operation, in that they step down the voltage by an integer multiple while stepping up the current by the same integer multiple. As a result, the current injected into the battery can be multiplied from the input current supplied to the device by the adapter. This increased current can allow for higher battery charging rates. As one example, some PPS/USB-C/PD power adapters may have a 3A maximum current. By employing a charging configuration as described above, the battery charging current can be increased by an integer multiple determined by the topology of the switched capacitor converter, providing for an increased charging rate while keeping internal losses very low.

As the battery state of charge increases, the programmed current can be gradually reduced based on the battery specifications and overall system design and constraints. When the battery enters the voltage sensitive region, the switched capacitor converter can be turned off and a bypass buck regulator charger with fast control loop can be enabled to complete the charging process while maintaining sufficient regulation of battery terminal voltage and current.

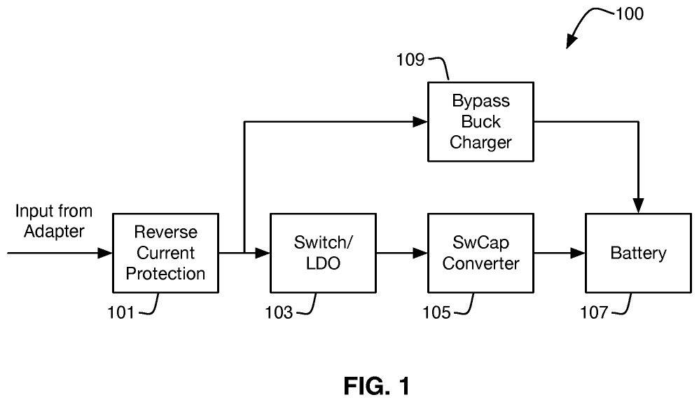

FIG. 1 illustrates a block diagram of a battery charger system 100. Input from a power adapter (not shown) is received by reverse current protection device 101. Reverse current protection device can be selected and configured to provide appropriate fault protection. Downstream of reverse current protection device 101, the power feed can be separated in two branches. Only one of the two branches will be active at any given time. A first branch is passed to switch/low dropout regulator 103, which can provide power to a switched capacitor converter 105. Thus, this branch of the circuit can achieve fast charging of battery 107 using a PPS mode of the input adapter. The other branch off reverse current protection device 101 can be used to power a bypass buck converter charger 109. Bypass buck converter charger 109 can be configured with control circuitry implementing a sufficiently fast control loop and sufficiently high setpoint precision to provide for suitable battery charging. Switch/LDO 103 at the input of capacitor divider 105 can be operated as a linear voltage regulator to handle fast load dump by the system during a fast charging stage.

Although this charging configuration can be used for fast battery charging, its effectiveness is constrained by the need to have a power adapter with the above-described PPS capability (or similar). Even if a power adapter has a sufficiently high power rating, if it lacks PPS capability, then the electronic device must rely on charging through the bypass buck charger 109. Because bypass buck charger 109 may be designed with a significantly lower handling capability, the charging rate may be significantly limited, and thus the user's charging experience may be somewhat degraded. As one example, such devices may be capable of charging the battery to 50% state of charge in as little as 15 minutes (i.e., 2C charging) with a PPS capable adapter, while taking 3× to 4× longer to reach the same state of charge using a non-PPS adapter, even if the non-PPS adapter otherwise has a sufficiently high power rating.

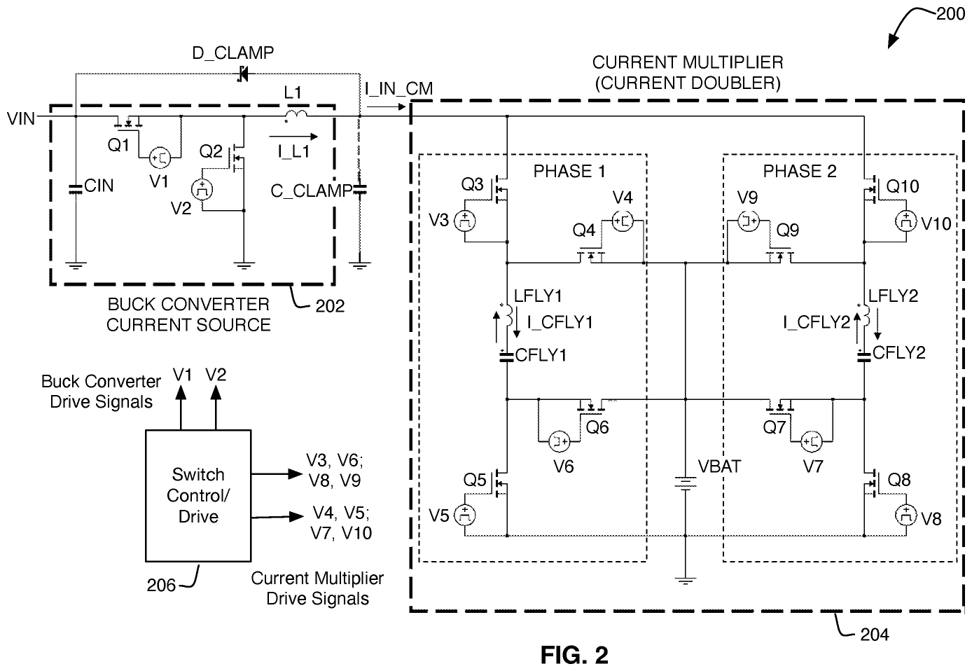

FIG. 2 illustrates a battery charger incorporating a current-fed quasi-resonant current multiplier 200 that can addresses these issues. Charger 200 can achieve fast charging rates either with or without PPS capable USB-C/USB-PD adapters. Although the charging rate with a non-PPS adapter may be slower than with a PPS adapter, the difference can be much less than in the system described above with respect to FIG. 1.

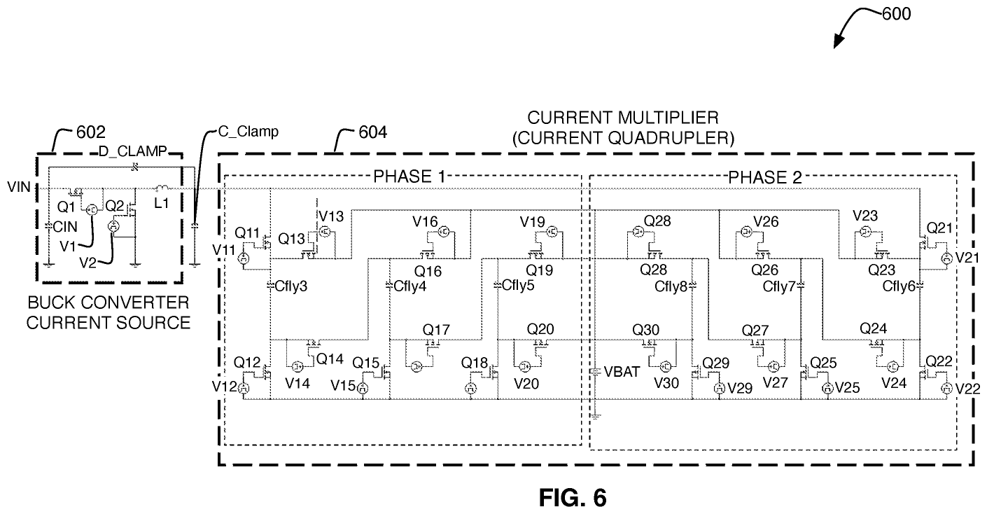

The current-fed quasi-resonant current multiplier 200 shown in FIG. 2 includes two circuit blocks, connected in series. The first circuit block is a buck converter, designed to operate as a current source 202. The second block is a current multiplier 204. The output current of buck converter 202 is directly fed into current multiplier 204. In the illustrated embodiment, current multiplier 204 is a current doubler, but as described below with respect to FIG. 6, other current multiplier configurations, including current triplers, current quadruplers, etc. may also be used.

Buck converter current source 202 receives an input voltage Vin, for example from an AC/DC adapter (not shown). Buck converter current source 202 can include a main switching device Q1, an auxiliary switching device Q2, and a buck inductor L1. Control circuitry 206 can be used to generate the gate drive signals V1 for main switching device Q1 and V2 for auxiliary switching device Q2. In general, switching device Q1 will be turned on while switching device Q2 is turned off, and vice versa. Switching devices Q1 and Q2 may thus be described as complementary switching devices. The switching duty cycle can be determined by the buck converter current source control circuitry 206 using a current feedback loop to generate the switching device gate drive signals to maintain the buck converter output current I_L1 at a desired value determined by the battery charging controller. The control circuitry 206 can be implemented using any suitable combination of analog, digital, and/or programmable circuitry implemented with any suitable combination of discrete or integrated circuit components. In some cases, the control circuitry 206 can include application specific integrated circuits (ASICs) and/or programmable microcontrollers. In some embodiments, switching device Q2 could be replaced with a freewheeling diode; however, the synchronous switching capability afforded by use of a controlled switching device can allow for improved operating efficiency.

As noted above, the regulated output current (I_L1) of buck converter current source 202 can be provided as the input current (I_IN_CM) to current multiplier 204. Current multiplier 204 as illustrated in FIG. 2 is not strictly a traditional switched capacitor divider, but rather an improved version that employs a similar operational sequence but a different overall function. In the proposed topology, each flying capacitor CFLY1 and CFLY2 is charged by an internally controlled current source and discharged in a resonant manner to deliver energy to the output. This operation overcomes some of the limitations of traditional switched capacitor dividers, which operate on the principle of charge transfer through a resistive element. As a result of the “capacitor to capacitor” direct charge transfer method, such capacitive dividers can have Slow Switching Limit (SSL) and Fast Switching Limit (FSL) limitations that can require the use of large flying capacitors (i.e., flying capacitors having large capacitance values) to keep the switching frequency at the desired target. Alternatively, the illustrated current multiplier 204 employs resonant charge transfer with operation close to the resonant frequency of the tank circuit, which can allow for more optimization of the hardware.

As noted above, the switched capacitor current multiplier uses an internally regulated current source to charge the flying capacitors. This internally regulated current source includes the flying inductances LFLY1 and LFLY2 coupled in series with flying capacitors CFLY1 and CFLY2, respectively. These inductances, together with the current fed nature of current multiplier 204 and the resonant mode operation of the current multiplier's switching devices together allow for regulation of currents I_CFLY1 and I_CFLY2 to provide the above-described operation. The flying inductances used to form the internally controlled current source of current multiplier 204 can be implemented as discrete inductors. However, depending on a variety of circuit design parameters, including the target resonant frequency, the value of such inductors may be quite small, e.g., in the range 1 nH to 5 nH. In these applications, the required inductance can be implemented using parasitic inductances of various circuit elements and/or the layout of the circuit (e.g., PCB trace length).

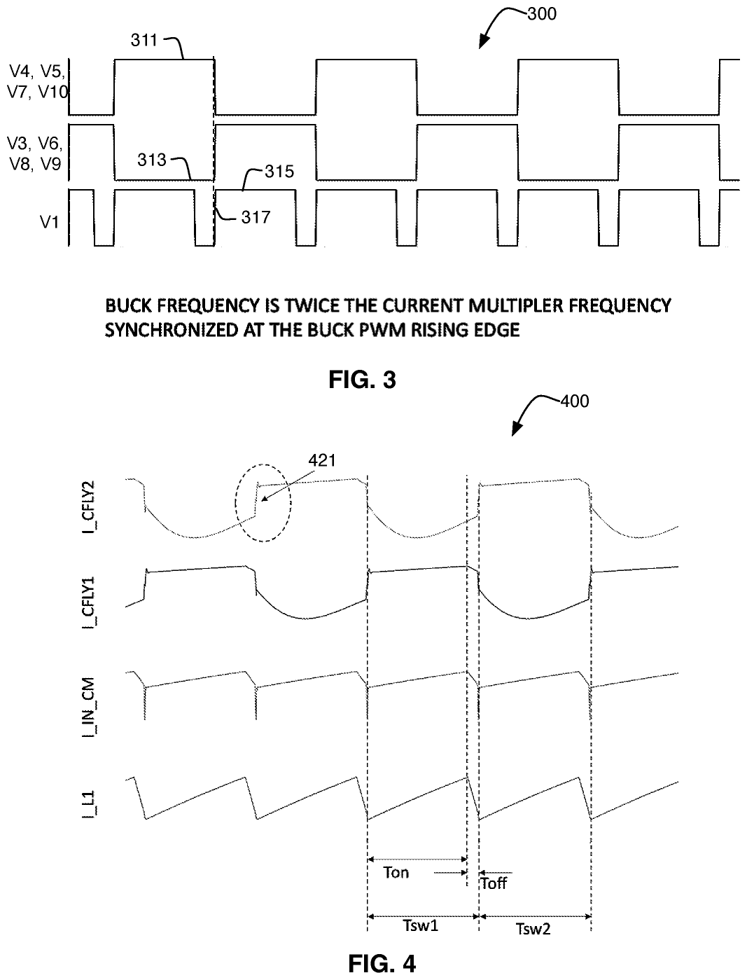

In the illustrated embodiment, current multiplier 204 is an interleaved two-phase circuit. In other words, there are two phases, shown as PHASE1 and PHASE2. Thus, PHASE 1 includes high side complementary switch pair Q3/Q4, flying inductance LFLY1, flying capacitor Cfly1, and low side complementary switch pair Q5/Q6. Similarly, PHASE 2 includes high side complementary switch pair Q9/Q10, flying inductance LFLY1, flying capacitor Cfly1, and low side complementary switch pair Q7/Q8. Each phase operates with a 180-degree phase-shift relative to the other, as can be seen in greater detail below with respect to FIGS. 3-5. In some embodiments, a single-phase current multiplier could be provided, at the cost of increased ripple. In other embodiments, more phases could be provided. If higher numbers of phases are provided, the interleaving can be evenly spaced across 360 degrees of the switching cycle. In other words, a three phase converter could have each phase switching with a 120 degree angle between phases, a four phase converter could have each phase switching with a 90 degree angle between phases, etc.

Each current multiplier phase itself operates with a duty cycle that is substantially 50% barring a small dead time (i.e., as little as practicable) to prevent cross conduction. By this, it is meant that one switch of the high side complementary switch pair and a corresponding switch of the low side complementary switch pair are turned on at the same time to allow for input energy to be stored in the resonant circuit. For example, switch Q3 and Q6 can be turned on (with switches Q4 and Q5 turned off) to charge flying capacitor CFLY1 (in series with the battery). Then, at the next switching transition, each complementary switch pair swaps states, allowing for energy stored in the resonant circuit to discharge to the battery. For example, switches Q3 and Q6 turn off, switches Q4 and Q5 turn on, allowing flying capacitor CFLY1 to discharge energy into the battery via a parallel connection. In practical applications, there may be a short dead time between the operation of the two phases. To avoid an open circuit condition for the energized inductor, clamp diode D_CLAMP placed such that the peak voltage at the current multiplier input is clamped to the input capacitor of the buck converter. In some applications, it may be desirable for diode D_Clamp to have a low forward drop and low reverse recovery characteristics, e.g., a Schottky diode.

Current multiplier switch drive signals V3, V4, V5, and V6 that achieve the above-described operation can also be generated by control circuitry 206 implemented as described above. Current multiplier drive signals V3, V6, V8, and V9 can be identical while drive signals Q4, Q5, Q7, and Q10 can be identical but 180 degrees out of phase (as illustrated in FIG. 3). Current multiplier 204 can share control circuitry 206 with buck converter current source 202 or can have its own control circuitry. However, requirements for certain operating conditions described below would require some degree of timing synchronization between separate control circuitries. More specifically, and as described above, the buck converter can be operated as a current source with the buck inductor current fed directly into to the current multiplier. The frequency of current pulses delivered by buck converter current source 202 can be an even multiple of the current multiplier operating frequency. For example, if the current multiplier is operating at 1 MHZ, then the current pulses delivered by buck current source can be at 2 MHZ, 4 MHZ, 6 MHZ, etc. Additionally, switching of current multiplier 204 can be synchronized with the buck converter current source 202 as illustrated below with respect to FIG. 3. If buck converter current source 202 is implemented as a multi-phase buck converter, then the frequency of the current pulses being injected into current multiplier 204 can still meet the defined frequency relationship (i.e., even integer multiple) described above. Complying with these conditions results in current-fed, semi-resonant operation of the converter, explained in greater detail below with respect to FIG. 4. (By semi-resonant, it is meant that the flying capacitors discharge in a resonant manner.)

An implementation as described in the preceding paragraph allows the use of a clamp capacitor C_CLAMP instead of a clamp diode D_CLAMP to absorb the energy in the buck inductor during the dead time. Such a clamp capacitor can have relatively small value, with the design goal of preventing large overshoot during the dead time between the operation of two phases of the current multiplier. The overall operation remains current fed by virtue of the synchronization and frequency relationship described above. In at least some embodiments, one advantage of using a clamp capacitor C_CLAMP may be reduced voltage stress on current multiplier devices. Thus, such an embodiment may be preferred when implementing integrated circuits.

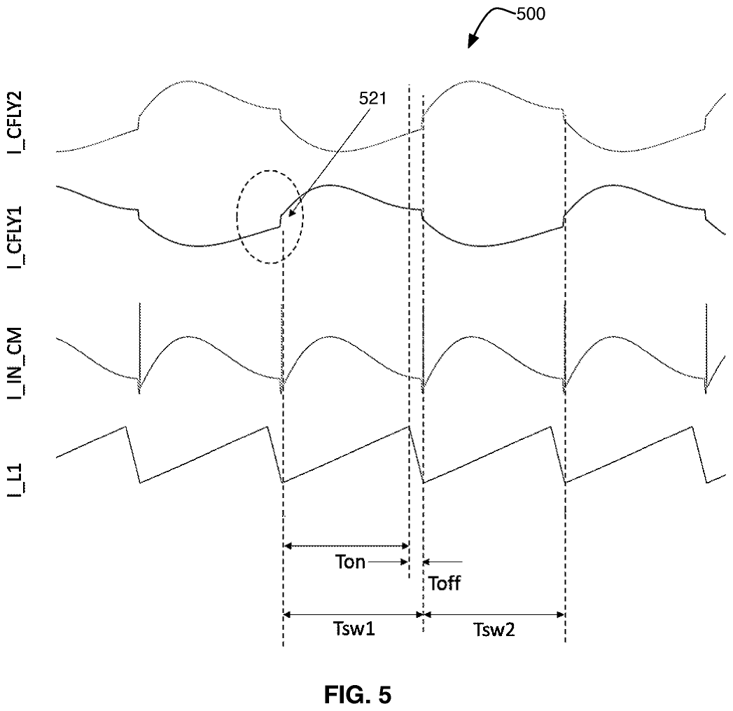

Otherwise, if the frequency/phase relationship between buck converter current source 202 and current multiplier 204 cannot be maintained as described above, then a clamp capacitor C_CLAMP can be provided at the input of the current multiplier. This can alter the operation of the topology to be voltage-fed, resonant current multiplier that can still deliver most of the benefits of the current-fed embodiment. (By resonant, it is meant that the flying capacitors both charge and discharge in a resonant manner, as illustrated below with respect to FIG. 5.) In voltage-fed operating mode, the flying capacitor(s) of the current multiplier will charge as well as discharge in resonant manner. In some applications and/or under certain operating conditions, this mode of operation may be preferred due to practical design limitations.

To summarize, the phase synchronization and switching frequency multiple relationship between the buck converter current source 202 and current multiplier 204 described above is provided, then either a clamp capacitor C_CLAMP or clamp diode D_CLAMP may be used. Additionally, if a clamp capacitor is used, the capacitance of C_CLAMP can be relatively low. However, if this frequency/phase relationship is not or cannot be provided/maintained for all operating conditions, then use of a clamp capacitor C_CLAMP becomes mandatory. Additionally, the capacitance of C_CLAMP should be relatively high to provide a stiff voltage source at the input of the current multiplier.

FIG. 3 illustrates switch drive signals 300 of the buck-fed quasi-resonant current multiplier of FIG. 2. As described above, control circuitry 206 can be used to generate the gate drive signals V1 for main switching device Q1 and V2 for auxiliary switching device Q2 of buck converter current source 202. Trace 315 of FIG. 3 illustrates the drive signal of buck converter main switch Q1, with a high level corresponding to switch Q1 being turned on and a low level corresponding to switch Q1 being turned off. The drive signal of buck converter auxiliary switch Q2 (if provided, as opposed to a freewheeling diode) can be the complement of the illustrated V1 waveform 315. In other words, V2 can be high when V1 is low, turning on switch Q2 when switch Q1 is off, and vice versa.

Additionally, as noted above, current multiplier drive signals V3, V6, V8, and V9 (trace 313) can be identical while drive signals Q4, Q5, Q7, and Q10 (trace 311) can be identical but 180 degrees out of phase (as illustrated in FIG. 3). Additionally, because the buck converter current source operates at an even integer multiple of the current multiplier circuit, there are two cycles trace 315 (the buck converter drive signal) for every single cycle traces 311, 313 (the current multiplier drive signals). Additionally, switching operations of the buck converter current source and the current multiplier can be synchronized, e.g., on main buck switch rising edge 317.

FIG. 4 illustrates various current waveforms 400 of the buck-fed quasi-resonant current multiplier of FIG. 2 operating in the current-fed quasi-resonant mode described above. In FIG. 4, waveform I_L1 illustrates triangular current pulses delivered by the front-end buck converter current source 202. Waveform I_IN_CM illustrates current pulses injected in the two-phase current multiplier. The subtle difference between waveform I_L1 and waveform I_IN_CM illustrates the clamping effect of the clamp diode D_CLAMP. During the short dead time, the inductor current is clamped through D_CLAMP and I_IN_CM drops to zero. Waveforms I_CFLY1 and I_CFLY2 illustrate the charging and discharging currents in the respective flying capacitors. As can be seen, the interleaved operation of the respective phases means that CFLY1 is charging while CFLY2 is discharging, and vice versa.

In steady state operation, buck converter current source 202 can regulate the average output current. Either an average current mode control loop or a peak current mode control loop can be implemented by the control circuitry 206 for this purpose. The switching clocks of buck converter current source 202 and current multiplier 204 can be synchronized on the rising edge of the buck converter as described above. With further reference to FIGS. 3 and 4, as noted above, buck converter 202 operates at twice the frequency of the current multiplier (in this example). The main switching device Q1 of buck converter current source 202 and charge control switches of PHASE 1 of current multiplier 204 (i.e., Q4/Q5) associated with flying capacitor CFLY1 can turn on simultaneously. One complete current pulse, which includes magnetization and demagnetization of the inductor L1 can thus be injected in flying capacitor CFLY1 during time duration Tsw1. Charge control switches Q4/Q5 of PHASE 1 of current multiplier 204 can be turned off exactly at the end of the total switching period of the buck converter, i.e., at the end of Tsw1. When the next switching cycle for the buck converter starts, the charge control switches of PHASE 2 of current multiplier 204, i.e., switches Q8/Q9 associated with flying capacitor CFLY2 can be turned on. The next current pulse delivered by the buck inductor in the next switching period Tsw2 can thus be injected in CFLY2. Thus, flying capacitor CFLY1 and CFLY2 receive charging energy in alternate switching periods of the buck converter. Since the value of the flying inductors LFLY1 and LFLY2 is extremely small as compared to L1, the current injected in the flying capacitor has identical shape as the current in buck inductor.

When the charging half cycle of each respective phase of the current multiplier ends, a discharge cycle for the flying capacitor starts. As described above, the flying capacitor connects in parallel with the output (i.e., the battery being charged) still in series with the corresponding flying inductor. Because the battery is a stiff voltage source with very low impedance as compared to flying capacitor, the energy stored in the flying capacitor is transferred to the battery in a resonant manner.

As an aside, consumer electronics applications implementing charging circuitry as described herein may have relatively small space allocated for the charging circuitry. Because of these space requirements, film capacitors or highly stable COG type ceramic capacitors, which are often used in resonant tank circuits, may not practical for some applications. Otherwise, to maximize energy density, X5R or X7R dielectric based ceramic capacitors might be practical. However, such capacitors have a voltage dependency in which capacitance varies significantly with DC bias. This issue can be addressed as described below.

The average DC bias on each flying capacitor is substantially the same as the battery voltage. A small AC ripple is also present across the flying capacitors during charge-discharge cycles. Additionally, the minimum and maximum voltage range of the battery in fast charge operation is known in advance. For example, a single cell of lithium-ion battery can be charged over a voltage range of 3.6V to 4.4V, which can also be expressed as a charging range of 4.00V+/−10%. When the flying capacitor values are selected for a given application, their minimum capacitance (including manufacturing tolerance, operating temperature range, etc.) at 4.4V DC bias can be identified. The tank circuit including the flying capacitor and flying inductor can thus be configured by selecting capacitance and inductance values such that at the 4.4V DC bias, the resonant frequency of the tank is equal to or marginally lower than the switching frequency of the current multiplier. Additionally, the resonant frequency of the tank must be higher than half the switching frequency of the current multiplier.

In other words, the discharge current pulse must complete a quarter resonant time, but not the half resonant time, in a given switching cycle. Thus, a precise resonant frequency of the tank circuit is not critical, so long as the current in the tank circuit during the discharge cycle of the flying capacitor completes at least a quarter resonant period, but not the half resonant period of the tank circuit. This can be seen in the waveforms of FIG. 4. The discharge of the flying capacitor starts in a resonant manner, completes the quarter resonant period, but the resonant half cycle period is not completed during the set discharge time. Thus, when the switch connecting flying capacitor to the battery turns off, there is still some energy left in the flying inductor and it discharges at a linear ramp 421 as marked by the dashed circle in FIG. 4.

As noted above, a small filter capacitor (shown as C_CLAMP in FIG. 2) can be used at the input of current multiplier 204 to prevent voltage overshoot during the dead time. However, this slightly alters the operation, and a partial resonance can take place between C_CLAMP and the flying capacitors. If the value of C_CLAMP is set sufficiently high, then buck converter current source 202 will operate as a stiff voltage source rather than as a pulsed current source. In such case, the charging current in flying capacitors CFLY1 and CFLY2 will not be triangular but resonant in nature. FIG. 5 illustrates various current waveforms of associated with this operating mode.

As with FIG. 4, waveform I_L1 illustrates triangular current pulses delivered by the front-end buck converter current source 202. Waveform I_IN_CM illustrates current pulses injected in the two-phase current multiplier. Waveforms I_CFLY1 and I_CFLY2 illustrate the charging and discharging currents in the respective flying capacitors. As can be seen, the interleaved operation of the respective phases means that CFLY1 is charging while CFLY2 is discharging, and vice versa.

It can be seen in the waveforms of FIG. 5 that both the charging and discharging of the flying capacitor (I_CFLY1/I_CFLY2) is resonant in nature. The nature of charging and discharging current shape may be slightly different due to the difference in the quality factor (“Q”) of the tank circuit in the respective half cycles. This can be substantially explained by the effect of the different input and output impedances. If the capacitance value of clamp capacitor C_CLAMP is sufficient, then clamp diode D_CLAMP can be omitted.

Depending on the implementation of a particular design, it can be decided whether to use a clamp capacitor or not depending on whether the above-described frequency synchronization between the buck converter current source and the current multiplier is provided. If for some reason design limitations do not allow such synchronization, or if the two power stages are completely unsynchronized, then use of clamp capacitor C_CLAMP may be required. Additionally, circuitry could be provided for selectively including clamp capacitor C_CLAMP in the circuit or excluding it from the circuit depending on the desired operating mode. For example, a switch in series with the clamp capacitor could be provided to selectively connect or disconnect it from the circuit. The same applies to clamp diode D_CLAMP. Transition 521 illustrates the effect of the clamp components.

FIG. 6 illustrates a schematic of a buck-fed quasi-resonant current multiplier 600 in which the current multiplier 604 is a current quadrupler. An input power source (e.g., an AC/DC adapter) capable of delivering an input voltage Vin of 20V can be used with the circuit 600 of FIG. 6 to charge a single cell lithium-ion battery. Buck converter current source 602 can be substantially as described above with respect to buck converter current source 202. Current multiplier (quadrupler) 604 has been illustrated without series flying inductances; however, it is understood that these may be present (e.g., as parasitic or trace inductances) to provide operation as described above. Additionally, current quadrupler 604 may be configured as described in Applicant's co-pending U.S. patent application entitled “Switched Capacitor Converter With Tap-Change Capability,” filed of even date herewith and incorporated by reference in its entirety, that allows the current multiplier to be selectively operated as a current multiplier, current tripler, current doubler, or passthrough, responsive to the input voltage.

When the buck-fed, quasi-resonant current multiplier circuits described above are used with a non-PPS adapter, the system can operate as a two-stage power converter. The front-end buck converter (202/602) can regulate the charging current as set by the control loop controlling battery charging. The current multiplier (204/604) can provide current gain depending upon the ratio of the current multiplier employed, including configurable current multipliers as described in the preceding paragraph. The current multiplier can multiply the current by the factor of 2, 3, 4, etc. provided that the input power source (i.e., power adapter) can provide the required current and voltage level. As the battery approaches full charge, the regulated current supplied by the buck converter can be reduced as determined by the battery charging profile implemented by the battery control circuitry. At the end of the charge, i.e., when the battery reaches full charge, the buck converter can enter into voltage regulation mode. For closed loop operation, the current and voltage of the battery can be sensed and the control loop is closed on the buck converter placed at the front end. In this configuration, the buck converter may operate at a very high duty cycle because the reflected battery voltage appearing at the input of current multiplier is a multiple of the actual cell voltage corresponding to the current multiplication ratio. As a result, the buck converter can operate with a relatively high efficiency. Even though the power conversion uses two stages, overall efficiency can still be quite high due to favorable operating conditions for each of the power stages.

When a PPS capable USB-C/USB-PD adapter is available, current regulation can be performed by the PPS-capable adapter, and the internal front end buck converter can be operated in bypass mode. In other words main buck switch Q1 can be permanently kept ON and the auxiliary synchronous rectifier switch Q2 can be disabled. Even though PPS-capable adapter regulates the current, a stiff current is injected in the current multiplier because of the presence of inductor L1. As described above, clamp diode D_CLAMP prevents voltage overshoot during the short dead time in the current multiplier. If clamp capacitor C_CLAMP is used, then a clamp diode may not be necessary. The charging current can be increased or decreased by sending the appropriate current setting command to the adapter through the USB-C/USB-PD digital communication. As the battery approaches the end of the charge, the internal front-end buck is re-enabled and takes over the current and voltage regulation associated with battery charging.

Additionally, even if discrete flying inductors are not used and layout parasitic inductance is kept at minimum, several benefits of the above-described architecture can be realized provided the capacitive divider meets the SSL and FSL requirements of the design, as briefly described above.

The foregoing describes exemplary embodiments of buck-fed, quasi-resonant current multiplier converters. Such configurations may be used in a variety of applications but may be particularly advantageous when used in conjunction with charging circuits for electronic devices. Although numerous specific features and various embodiments have been described, it is to be understood that, unless otherwise noted as being mutually exclusive, the various features and embodiments may be combined various permutations in a particular implementation. Thus, the various embodiments described above are provided by way of illustration only and should not be constructed to limit the scope of the disclosure. Various modifications and changes can be made to the principles and embodiments herein without departing from the scope of the disclosure and without departing from the scope of the claims.

1. A buck-fed current multiplier battery charging circuit comprising:
a buck converter having an input configured to receive an input voltage and an output configured to deliver a regulated current;
a current multiplier having an input configured to receive the regulated current from the buck converter and an output configured to deliver a multiple of the regulated current to a battery, wherein the current multiplier comprises one or more flying capacitor stages each including a resonant tank circuit; and
controller circuitry coupled to the buck converter that operates switches of the buck converter to produce the regulated current and coupled to the current multiplier that operates switches of the current multiplier to deliver the multiple of the regulated current to the battery.

2. The buck-fed current multiplier battery charging circuit of claim 1 wherein the one or more flying capacitor stages includes at least one first flying capacitor stage forming a first phase of the current multiplier and at least one second flying capacitor stage forming a second phase of the current multiplier, wherein the first and second phases are operated in an interleaved manner to reduce current or voltage ripple.

3. The buck-fed current multiplier battery charging circuit of claim 1 wherein each of the one or more flying capacitor stages comprises:
a flying capacitor and a flying inductance forming the resonant tank circuit;
a high side complementary switch pair coupled to a first terminal of the resonant tank circuit; and
a low side complementary switch pair coupled to a second terminal of the resonant tank circuit.

4. The buck-fed current multiplier battery charging circuit of claim 3 wherein the flying inductance includes a parasitic inductance.

5. The buck-fed current multiplier battery charging circuit of claim 3 wherein the flying inductance consists of parasitic inductances.

6. The buck-fed current multiplier battery charging circuit of claim 3 wherein the controller circuitry operates the high side complementary switch pair and the low side complementary switch pair of the one or more of the flying capacitor stages with a 50% duty cycle to alternate between charging the flying capacitor in series with the battery and discharging the flying capacitor in parallel with the battery.

7. The buck-fed current multiplier battery charging circuit of claim 6 wherein the one or more flying capacitor stages discharge with a quasi-resonant current.

8. The buck-fed current multiplier battery charging circuit of claim 6 wherein the one or more flying capacitor stages charge with a quasi-resonant current.

9. The buck-fed current multiplier battery charging circuit of claim 1 further comprising a clamp diode coupled between the output of the buck converter and the input of the buck converter.

10. The buck-fed current multiplier battery charging circuit of claim 1 further comprising a clamp capacitor coupled to the output of the buck converter.

11. The buck-fed current multiplier battery charging circuit of claim 1 wherein the controller circuitry operates the buck converter at a switching frequency that is synchronized with and an even integer multiple of a switching frequency of the current multiplier.

12. The buck-fed current multiplier battery charging circuit of claim 1 wherein the controller circuitry operates the buck converter at a switching frequency that is not synchronized with or a multiple of the switching frequency of the current multiplier.

13. The buck-fed current multiplier battery charging circuit of claim 1 wherein the current multiplier comprises at least three flying capacitor stages, providing for selection of integer multiples of 4×, 3×, 2×, or 1×.

14. A method of operating a buck-fed current multiplier battery charging circuit, the method comprising:
operating a buck converter input stage at a first switching frequency to produce a regulated current;
operating a current multiplier stage at a second switching frequency to produce a battery charging current that is an integer multiple of the regulated current, wherein the current multiplier stage comprises one or more flying capacitor stages including a resonant tank circuit.

15. The method of claim 14 wherein each of the one or more flying capacitor stages comprises:
a flying capacitor and a flying inductance forming the resonant tank circuit;
a high side complementary switch pair coupled to a first terminal of the resonant tank circuit; and
a low side complementary switch pair coupled to a second terminal of the resonant tank circuit;
wherein operating the current multiplier stage comprises operating the high side complementary switch pair and the low side complementary switch pair of the one or more flying capacitor stages with a 50% duty cycle to alternate between charging the flying capacitor in series with a battery and discharging the flying capacitor in parallel with the battery.

16. The method of claim 15 wherein the one or more flying capacitor stages discharge with a quasi-resonant current.

17. The method of claim 16 wherein the one or more flying capacitor stages charge with a quasi-resonant current.

18. The method of claim 15 wherein the first switching frequency is synchronized with and an even integer multiple of the second switching frequency.

19. The method of claim 15 wherein the first switching frequency is not synchronized with the second switching frequency.

20. A battery charging circuit comprising:
means for generating a regulated current from an input voltage source; and
means for generating a battery charging current that is an integer multiple of the regulated current from the regulated current;
wherein the means for generating the battery charging current includes one or more resonant tank circuits that are alternated between a first state that includes storing energy in the resonant tank circuit and discharging energy from the resonant tank circuit to the battery.

21. The battery charging circuit of claim 20 wherein the one or more resonant tank circuits discharge with a quasi-resonant current.

22. The battery charging circuit of claim 21 wherein the one or more resonant tank circuits charge with a quasi-resonant current.
